(19) United States
(12) Patent Application Publication
(10) Pub. No.: US 2025/0117931 A1
(43) Pub. Date: Apr. 10, 2025

(54) CROSS-MODALITY VASCULAR IMAGE SIDE BRANCH MATCHING

(71) Applicant: Boston Scientific Scimed, Inc., Maple Grove, MN (US)

(72) Inventors: Yan Li, Plymouth, MN (US); Hatice Cinar Akakin, Eden Prairie, MN (US); Wenguang Li, Los Gatos, CA (US); Kevin Bloms, Minneapolis, MN (US)

(73) Assignee: Boston Scientific Scimed, Inc., Maple Grove, MN (US)

(21) Appl. No.: 18/904,145

(22) Filed: Oct. 2, 2024

Related U.S. Application Data
(60) Provisional application No. 63/588,571, filed on Oct. 6, 2023.

(51) Int. Cl. G06T 7/00; G06T 7/30; G06T 7/62; G06V 10/74

(52) U.S. Cl. CPC G06T 7/0012; G06T 7/30; G06T 7/62; G06V 10/761; G06T 2207/10081; G06T 2207/10101; G06T 2207/10132; G06T 2207/30101

(57) ABSTRACT

The present disclosure provides to match side branches from different imaging modalities. Side branches detected from a series of intravascular images can be matched with side branches detected from an extravascular image. The pairs of matches can be determined based on an initially identified reference pair and then a technique that accounts for the characteristics of the side branch, such as, the diameter, the orientation, the relative size, and/or the relative order.

### CROSS-REFERENCE TO RELATED APPLICATIONS

This application claims the benefit of U.S. Provisional Patent Application Ser. No. 63/588,571 filed on Oct. 6, 2023, the disclosure of which is incorporated herein by reference.

### TECHNICAL FIELD

The present disclosure pertains to angiography and intravascular or extravascular imaging modalities and to matching side branches identified in one imaging modality with side branches identified in another imaging modality.

### BACKGROUND

Ultrasound devices insertable into a patient's vasculature have proven diagnostic capabilities for a variety of diseases and disorders. For example, intravascular ultrasound (IVUS) imaging systems have been used as an intravascular imaging modality for diagnosing blocked blood vessels and providing information to aid medical practitioners in selecting and placing stents, selecting sites for an atherectomy procedure, or the like.

IVUS imaging systems includes a control module (with a pulse generator, an image acquisition and processing components, and a monitor), a catheter, and a transducer disposed in the catheter. The transducer-containing catheter is positioned in a lumen or cavity within, or in proximity to, a region to be imaged, such as a blood vessel wall or patient tissue in proximity to a blood vessel wall. The pulse generator in the control module generates electrical pulses that are delivered to the transducer and transformed to acoustic pulses that are transmitted through patient tissue. The patient tissue (or other structure) reflects the acoustic pulses and reflected pulses are absorbed by the transducer and transformed to electric pulses. The transformed electric pulses are delivered to the image acquisition and processing components and converted into images displayable on the monitor.

Coronary angiography (angiogram) or CT coronary angiography (CTA or CCTA) is the use of X-ray imaging modalities to assess the coronary arteries of the heart. Typically, a patient receives an intravenous injection of contrast agent and then the heart is scanned using a high speed CT scanner. CTA and IVUS are often used in conjunction with each other. For example, a physician will use the X-ray imaging modality and the IVUS to assess the extent of an occlusion (or occlusions) in the coronary arteries, usually to diagnose coronary artery disease.

To aid physicians in reviewing these images, they are often co-registered to each other. For example, each image in a series of IVUS images can be mapped, or co-located, to a position of the vessel represented in the X-ray image. Co-registration of angiography and IVUS images is a transformative technique that enhances the assessment of coronary artery disease by offering a comprehensive understanding of plaque composition, severity, and vessel anatomy. This advancement significantly improves the precision of stent placement, treatment strategizing, and lesion monitoring.

Thus, there is a need for improved co-registration techniques and workflows.

### BRIEF SUMMARY

The present disclosure provides a system configured to match side branches detected in one imaging modality (e.g., IVUS, or the like) with side branches detected in another, different, imaging modality (e.g., angiography, or the like) and to adjust the side branches based on the matching. In general, the present disclosure provides to match the side branches based on the location, size, and orientation of the side branches. This disclosure provides advancements to the technology of co-registration in that it enables automated co-registration, thereby reducing the need for manual intervention and enhancing the accuracy of the co-registration.

With some embodiments, the disclosure can be implemented as a method for cross modality image co-registration. The method can comprise identifying, by a computing device, first side branches in a first image frame, the first image frame corresponding to a first imaging modality; identifying, by the computing device, second side branches in a plurality of second image frames, the plurality of second image frames corresponding to a second imaging modality different than the first imaging modality; matching, by the computing device without user input, ones of the first side branches with ones of the second side branches; and co-registering the plurality of second image frames with the first image frame based on the matching, wherein co-registering the plurality of second image frames comprises adjusting locations of the second side branches on the first image frame.

In further embodiments of the method, the first imaging modality is x-ray angiography and where the second imaging modality is intravascular ultrasound, optical coherence tomography, or computed tomography (CT) angiography.

In further embodiments of the method, matching ones of the first side branches with ones of the second side branches comprises identifying, by a computing device, one of a plurality of first side branches and one of a plurality of second side branches as a reference pair of side branches; identifying, by the computing device, a plurality of candidate pairs of side branches based in part on the reference pair of side branches, wherein each candidate pair of side branches of the plurality of candidate pairs includes at least one of the plurality of first side branches and at least one of the plurality of second side branches; and identifying, by the computing device, a plurality of matched pairs of side branches from the plurality of candidate pairs of side branches based in part on characteristics of the plurality of first side branches and the plurality of second side branches, wherein each pair of the plurality of matched pairs of side branches includes a one of the plurality of first side branches and a one of the plurality of second side branches.

In further embodiments of the method, the characteristics includes one or more of a diameter of the side branch, an orientation of the side branch, a relative size of the side branch, or a relative location of the side branch.

In further embodiments of the method, identifying one of the plurality of first side branches and one of the plurality of second side branches as the reference pair of side branches comprises identifying, by the computing device, the distance along a centerline of the vessel between bifurcations in the first side branches and the second side branches; determining if the distance between trifurcations in the first side branches and the second side branches is less than a threshold distance; and designating, based on a determination that the distance between trifurcations is less than the threshold distance, the pair of first and second side branches as the reference pair of side branches.

In further embodiments, the method can comprise determining whether more than one pair of first and second side branches are identified as having the distance between trifurcations of less than the threshold distance; and designating, based on a determination that more than one pair of first and second side branches has the distance between trifurcations of less than the threshold distance, the pair of first and second side branches having the smallest distance between trifurcations as the reference pair of side branches.

In further embodiments, the method can comprise determining whether more than one pair of first and second side branches are identified as having the distance between trifurcations of less than the threshold distance; and designating, based on a determination that more than one pair of first and second side branches has the distance between trifurcations of less than the threshold distance, the pair of first and second side branches having the smallest weight as the reference pair of side branches.

In further embodiments of the method, the weight is defined as the sum of the difference between the distance between trifurcation and the difference between the diameter of the side branches.

In further embodiments, the method can comprise identifying, based on a determination that the distance between trifurcations is not less than the threshold distance, the distance along the centerline between first and second side branches; determining if the distance along the centerline between first and second side branches is less than the threshold distance; and designating, based on a determination that the distance between first and second side branches is less than the threshold distance, the first and second side branches as the reference pair of side branches.

In further embodiments, the method can comprise increasing the threshold distance, based on a determination that the distance between first and second side branches is not less than the threshold distance.

In further embodiments, the method can comprise determining whether more than one pair of first and second side branches are identified as having the distance between side branches along the centerline of less than the threshold distance; and designating, based on a determination that more than one pair of first and second side branches has the distance between side branches along the centerline of less than the threshold distance, the pair of first and second side branches having the smallest distance between aide branches along the centerline as the reference pair of side branches.

In further embodiments, the method can comprising determining whether more than one pair of first and second side branches are identified as having the distance between side branches along the centerline of less than the threshold distance; and designating, based on a determination that more than one pair of first and second side branches has the distance between side branches along the centerline of less than the threshold distance, the pair of first and second side branches having the smallest weight as the reference pair of side branches, wherein the weight is defined as the sum of the difference between the distance between side branches along the centerline and the difference between the diameter of the side branches.

In further embodiments of the method, the confidence level is determined based in part on a difference between the diameter of the one of the plurality of first side branches and the one of the plurality of second side branches in each respective one of the plurality of matched side branch pairs.

With some embodiments, the disclosure can be implemented as a computer-readable storage device. The computer-readable storage device can comprise instructions executable by a processor of a computing device coupled to an intravascular imaging device and/or a fluoroscope device, wherein when executed the instructions cause the computing device to implement any of the methods disclosed herein.

With some embodiments, the disclosure can be implemented as an apparatus. The apparatus can comprise a processor arranged to be coupled to an intravascular imaging device and/or a fluoroscope device, the apparatus further comprising a memory comprising instructions, the processor arranged to execute the instructions to implement any of the methods disclosed herein.

With some embodiments, the disclosure can be implemented as an apparatus for a cross modality image co-registration system. The apparatus can comprise a processor arranged to be coupled to an intravascular imaging device and/or a fluoroscope device; and a memory storage device comprising instructions executable by the processor, which instructions when executed by the processor cause the apparatus to identify first side branches in a first image frame, the first image frame corresponding to a first imaging modality; identify second side branches in a plurality of second image frames, the plurality of second image frames corresponding to a second imaging modality different than the first imaging modality; match, without user input, ones of the first side branches with ones of the second side branches; and co-register the plurality of second image frames with the first image frame based on the matching, wherein co-registering the plurality of second image frames comprises adjusting locations of the second side branches on the first image frame.

In further embodiments of the apparatus, the first imaging modality is x-ray angiography and where the second imaging modality is intravascular ultrasound, optical coherence tomography, or computed tomography (CT) angiography.

In further embodiments of the apparatus, the instructions when executed to match ones of the first side branches with ones of the second side branches further cause the apparatus to identify one of a plurality of first side branches and one of a plurality of second side branches as a reference pair of side branches; identify a plurality of candidate pairs of side branches based in part on the reference pair of side branches, wherein each candidate pair of side branches of the plurality of candidate pairs includes at least one of the plurality of first side branches and at least one of the plurality of second side branches; and identify a plurality of matched pairs of side branches from the plurality of candidate pairs of side branches based in part on characteristics of the plurality of first side branches and the plurality of second side branches, wherein each pair of the plurality of matched pairs of side branches includes a one of the plurality of first side branches and a one of the plurality of second side branches.

In further embodiments of the apparatus, the characteristics includes one or more of a diameter of the side branch, an orientation of the side branch, a relative size of the side branch, or a relative location of the side branch.

In further embodiments of the apparatus, the instructions when executed identify one of the plurality of first side branches and one of the plurality of second side branches as the reference pair of side branches further cause the apparatus to identifying, by the computing device, the distance along a centerline of the vessel between bifurcations in the first side branches and the second side branches; determining if the distance between trifurcations in the first side branches and the second side branches is less than a threshold distance; and designating, based on a determination that the distance between trifurcations is less than the threshold distance, the pair of first and second side branches as the reference pair of side branches.

In further embodiments of the apparatus, the instructions when executed further cause the apparatus to determine whether more than one pair of first and second side branches are identified as having the distance between trifurcations of less than the threshold distance; and designate, based on a determination that more than one pair of first and second side branches has the distance between trifurcations of less than the threshold distance, the pair of first and second side branches having the smallest distance between trifurcations as the reference pair of side branches.

In further embodiments of the apparatus, the instructions when executed further cause the apparatus to determine whether more than one pair of first and second side branches are identified as having the distance between trifurcations of less than the threshold distance; and designate, based on a determination that more than one pair of first and second side branches has the distance between trifurcations of less than the threshold distance, the pair of first and second side branches having the smallest weight as the reference pair of side branches, wherein the weight is defined as the sum of the difference between the distance between trifurcation and the difference between the diameter of the side branches.

In further embodiments of the apparatus, the instructions when executed further cause the apparatus to identify, based on a determination that the distance between trifurcations is not less than the threshold distance, the distance along the centerline between first and second side branches; determine if the distance along the centerline between first and second side branches is less than the threshold distance; and designate, based on a determination that the distance between first and second side branches is less than the threshold distance, the first and second side branches as the reference pair of side branches.

In further embodiments of the apparatus, the instructions when executed further cause the apparatus to increase the threshold distance, based on a determination that the distance between first and second side branches is not less than the threshold distance.

In further embodiments of the apparatus, the instructions when executed further cause the apparatus to determine whether more than one pair of first and second side branches are identified as having the distance between side branches along the centerline of less than the threshold distance; and designate, based on a determination that more than one pair of first and second side branches has the distance between side branches along the centerline of less than the threshold distance, the pair of first and second side branches having the smallest distance between aide branches along the centerline as the reference pair of side branches.

In further embodiments of the apparatus, the instructions when executed further cause the apparatus to determine whether more than one pair of first and second side branches are identified as having the distance between side branches along the centerline of less than the threshold distance; and designate, based on a determination that more than one pair of first and second side branches has the distance between side branches along the centerline of less than the threshold distance, the pair of first and second side branches having the smallest weight as the reference pair of side branches, wherein the weight is defined as the sum of the difference between the distance between side branches along the centerline and the difference between the diameter of the side branches.

In further embodiments of the apparatus, the confidence level is determined based in part on a difference between the diameter of the one of the plurality of first side branches and the one of the plurality of second side branches in each respective one of the plurality of matched side branch pairs.

With some embodiments, the disclosure can be implemented as a computer-readable storage device. The computer-readable storage device can comprise instructions executable by a processor of a computing device coupled to an intravascular imaging device and/or a fluoroscope device, wherein when executed the instructions cause the computing device to identify first side branches in a first image frame, the first image frame corresponding to a first imaging modality; identify second side branches in a plurality of second image frames, the plurality of second image frames corresponding to a second imaging modality different than the first imaging modality; match, without user input, ones of the first side branches with ones of the second side branches; and co-register the plurality of second image frames with the first image frame based on the matching, wherein co-registering the plurality of second image frames comprises adjusting locations of the second side branches on the first image frame.

In further embodiments of the computer-readable storage device, the first imaging modality is x-ray angiography and where the second imaging modality is intravascular ultrasound, optical coherence tomography, or computed tomography (CT) angiography.

In further embodiments of the computer-readable storage device, the instructions when executed to match ones of the first side branches with ones of the second side branches further cause the computing device to identify one of a plurality of first side branches and one of a plurality of second side branches as a reference pair of side branches; identify a plurality of candidate pairs of side branches based in part on the reference pair of side branches, wherein each candidate pair of side branches of the plurality of candidate pairs includes at least one of the plurality of first side branches and at least one of the plurality of second side branches; and identify a plurality of matched pairs of side branches from the plurality of candidate pairs of side branches based in part on characteristics of the plurality of first side branches and the plurality of second side branches, wherein each pair of the plurality of matched pairs of side branches includes a one of the plurality of first side branches and a one of the plurality of second side branches.

In further embodiments of the computer-readable storage device, the characteristics includes one or more of a diameter of the side branch, an orientation of the side branch, a relative size of the side branch, or a relative location of the side branch.

In further embodiments of the computer-readable storage device, the instructions when executed identify one of the plurality of first side branches and one of the plurality of second side branches as the reference pair of side branches further cause the computing device to identifying, by the computing device, the distance along a centerline of the vessel between bifurcations in the first side branches and the second side branches; determining if the distance between trifurcations in the first side branches and the second side branches is less than a threshold distance; and designating, based on a determination that the distance between trifurcations is less than the threshold distance, the pair of first and second side branches as the reference pair of side branches.

In further embodiments of the computer-readable storage device, the instructions when executed further cause the computing device to determine whether more than one pair of first and second side branches are identified as having the distance between trifurcations of less than the threshold distance; and designate, based on a determination that more than one pair of first and second side branches has the distance between trifurcations of less than the threshold distance, the pair of first and second side branches having the smallest distance between trifurcations as the reference pair of side branches.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 illustrate a multi-modality side branch matching system, in accordance with at least one embodiment.

FIG. 2 illustrates a routine for matching side branches identified from a series of intravascular images with side branches identified from an extravascular image, in accordance with at least one embodiment.

FIG. 3 illustrates an example angiography image frame and identification of a reference pair, in accordance with at least one embodiment.

FIG. 4 illustrates a routine for identifying a reference pair, in accordance with at least one embodiment.

FIG. 5 illustrates an example angiography image frame and identification of candidate matches, in accordance with at least one embodiment.

FIG. 6 illustrates an example angiography image frame and identification of matched pairs, in accordance with at least one embodiment.

FIG. 7A illustrates an example angiography image frame and mapped intravascular side branches while FIG. 7B illustrates the angiography image frame and the adjustment of the mapped intravascular side branches, in accordance with at least one embodiment.

FIG. 8 illustrates a computer-readable storage medium in accordance with at least one embodiment.

FIG. 9 illustrates an example vascular imaging system, in accordance with at least one embodiment.

FIG. 10 illustrates a diagrammatic representation of a machine in the form of a computer system within which a set of instructions may be executed for causing the machine to perform any one or more of the methodologies discussed herein, according to an example embodiment.

### DETAILED DESCRIPTION

As noted above, the present disclosure provides systems and techniques to match side branches identified from different imaging modalities (e.g., IVUS and angiography). It is noted that although the present disclosure uses examples and describes techniques with reference to IVUS and angiography, any suitable extravascular imaging modality and intravascular imaging modality can be utilized. Further, the present disclosure relies on identified side branches and their information (e.g., location, size, orientation, etc.) The actual identification of the side branches is beyond the scope of this disclosure.

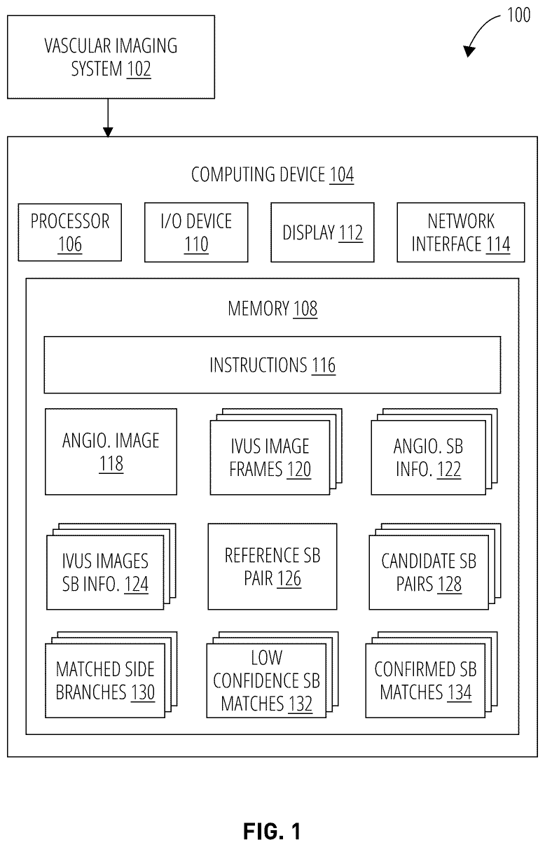

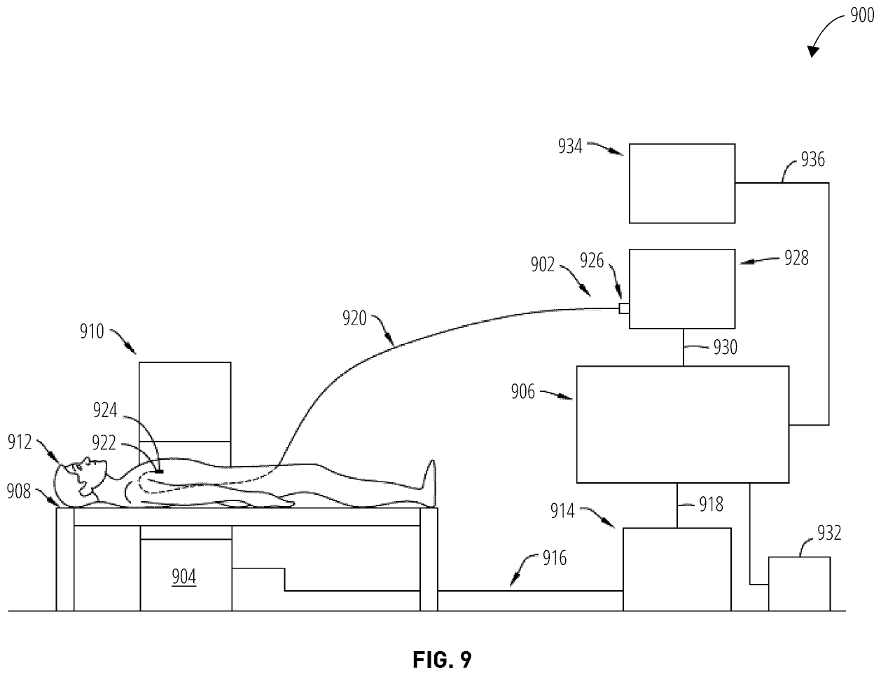

FIG. 1 illustrate a side branch matching system 100, in accordance with an embodiment of the present disclosure. In general, side branch matching system 100 is a system configured to side branches detected from an extravascular image (e.g., angiography) and side branches detected from intravascular images (e.g., IVUS). For example, side branch matching system 100 can be configured to match side branches detected from angiography image frame 118 with side branches detected from IVUS image frames 120. To that end, side branch matching system 100 includes, or can be coupled to, vascular imaging system 102. Vascular imaging system 102 can be any of a variety of vascular imaging systems configured to capture images from multiple imaging modalities (e.g., angiography, IVUS, intravascular OCT, or the like). An example of a vascular imager configured to capture both external (angiography) and internal (IVUS) vascular images is described with reference to the combined internal and external imaging system 900 depicted in FIG. 9.

Side branch matching system 100 includes computing device 104. Computing device 104 can be any of a variety of computing devices. In some embodiments, computing device 104 can be incorporated into and/or implemented by a console of vascular imaging system 102. With some embodiments, computing device 104 can be a tablet, laptop, workstation, or server communicatively coupled to vascular imaging system 102. With still other embodiments, computing device 104 can be provided by a cloud based computing device, such as, by a Computing as a Service (CaaS) system accessibly over a network (e.g., the Internet, an intranet, a wide area network, or the like). Computing device 104 can include processor 106, memory 108, input and/or output (I/O) device 110, and network interface 114.

The processor 106 may include circuity or processor logic, such as, for example, any of a variety of commercial processors. In some examples, processor 106 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 106 may include graphics processing portions and may include dedicated memory, multiple-threaded processing and/or some other parallel processing capability. In some examples, the processor 106 may be an application specific integrated circuit (ASIC) or a field programmable integrated circuit (FPGA).

The memory 108 may include logic, a portion of which includes arrays of integrated circuits, forming non-volatile memory to persistently store data or a combination of non-volatile memory and volatile memory. It is to be appreciated, that the memory 108 may be based on any of a variety of technologies. In particular, the arrays of integrated circuits included in memory 108 may be arranged to form one or more types of memory, such as, for example, dynamic random access memory (DRAM), NAND memory, NOR memory, or the like.

I/O devices 110 can be any of a variety of devices to receive input and/or provide output. For example, I/O devices 110 can include, a keyboard, a mouse, a joystick, a foot pedal, a haptic feedback device, an LED, or the like. Display 112 can be a conventional display or a touch-enabled display. Further, display 112 can utilize a variety of display technologies, such as, liquid crystal display (LCD), light emitting diode (LED), or organic light emitting diode (OLED), or the like.

Network interface 114 can include logic and/or features to support a communication interface. For example, network interface 114 may include one or more interfaces that operate according to various communication protocols or standards to communicate over direct or network communication links. Direct communications may occur via use of communication protocols or standards described in one or more industry standards (including progenies and variants). For example, network interface 114 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 114 can include logic and/or features to enable communication over a variety of wired or wireless network standards (e.g., 802.11 communication standards). For example, network interface 114 may be arranged to support wired communication protocols or standards, such as, Ethernet, or the like. As another example, network interface 114 may be arranged to support wireless communication protocols or standards, such as, for example, Wi-Fi, Bluetooth, ZigBee, LTE, 5G, or the like.

Memory 108 can include instructions 116, angiography image frame 118, IVUS image frames 120, angiography image side branch information 122, IVUS images side branch information 124, reference side branch pair 126, candidate side branch pairs 128, matched side branches 130, low confidence side branch matches 132, and confirmed side branch matches 134.

During operation, processor 106 can execute instructions 116 to cause computing device 104 to receive angiography image frame 118 and IVUS image frames 120 from vascular imaging system 102. With some examples, processor 106 can execute instructions 116 to cause computing device 104 to receive the angiography image frame 118 and the IVUS image frames 120 while they are captured. In other examples, processor 106 can execute instructions 116 to receive the angiography image frame 118 or the IVUS image frames 120 while it is captured where the other image modality will have been captured previously. In yet other examples, processor 106 can execute instructions 116 to cause computing device 104 to receive the angiography image frame 118 and the IVUS image frames 120, which were both previously captured. In any of these examples, processor 106 can execute instructions 116 to cause computing device 104 to receive data structures of information comprising indications of the angiography image frame 118 and IVUS image frames 120 (e.g., from vascular imaging system 102 directly, from network interface 114, from a memory location, or the like).

In general, angiography image frame 118 can be a CT images of a patient's heart (or portion of a patient's heart) captured after injection of a contrast agent into the patient's vasculature. With some examples, angiography image frame 118 can be a frame from a series of angiography image frames (e.g., cine-loop, or the like). Similarly, IVUS image frames 120 can be a series of ultrasound images captured from within a vessel of the patient's heart as an ultrasound probe is pulled back through a portion of the vessel. With some embodiments, angiography image frame 118 can be captured while IVUS image frames 120 is captured. In other embodiments, IVUS image frames 120 can be captured and then angio graphy image frame 118, or vice versa.

As introduced above, the present disclosure provides to “match” side branches detected from an extravascular image (e.g., angiography image frame 118) and intravascular images (e.g., IVUS image frames 120). To that end, angiography image side branch information 122 can be identified from angiography image frame 118 and IVUS images side branch information 124 can be identified from IVUS image frames 120. For example, processor 106 can execute instructions 116 to cause computing device 104 to identify angiography image side branch information 122 from angiography image frame 118 and to identify IVUS images side branch information 124 from IVUS image frames 120. In other examples, angiography image side branch information 122 and IVUS images side branch information 124 can be identified by another system and/or computing device and processor 106 can execute instructions 116 to receive (e.g., from network interface 114, from a memory location, or the like) data structures comprising indications of angiography image side branch information 122 and IVUS images side branch information 124.

Although the exact technique and system used to identify angiography image side branch information 122 and IVUS images side branch information 124 is beyond the scope of this disclosure, angiography image side branch information 122 and IVUS images side branch information 124 comprise indications of information about the side branches. For example, angiography image side branch information 122 can comprise an indication of a location (e.g., two-dimensional (2D) location, or the like) of each side branch, defined with respect to the angiography image frame 118. Further, angiography image side branch information 122 can comprise indications of a size (e.g., in millimeters, or the like) of each side branch as well as an orientation (e.g., left, right, etc.) of each side branch. Similarly, IVUS images side branch information 124 can comprise indications of a size and orientation (angular rotation, etc.) of each side branch detected based on the IVUS image frames 120.

The present disclosure provides to “match” the side branches detected based on IVUS image frames 120 with side branches detected based on angiography image frame 118 for purposes of co-registration of the images captured by these different image modalities.

In general, processor 106 can execute instructions 116 to cause computing device 104 to identify a side branch from angiography image side branch information 122 and a side branch from IVUS images side branch information 124 to designate as a reference side branch pair 126. Further, processor 106 can execute instructions 116 to identify candidate side branch pairs 128 from angiography image side branch information 122 and IVUS images side branch information 124. Candidate side branch pairs 128 comprise several “pairs” of side branches where each pair references a side branch from angiography image side branch information 122 and a side branch from IVUS images side branch information 124. It is noted that some side branches from either angiography image side branch information 122 or IVUS images side branch information 124 may be in multiple “pairs.” Said differently, candidate side branch pairs 128 may not define pairs of side branches having a 1 side branch to 1 side branch mapping between angiography image side branch information 122 and IVUS images side branch information 124.

Where candidate side branch pairs 128 comprises a pair that references a side branch in another pair, processor 106 can execute instructions 116 to cause computing device 104 to generate matched side branches 130 based on candidate side branch pairs 128. Where candidate side branch pairs 128 does not comprise a pair, there references a side branch in another pair, processor 106 can execute instructions 116 to cause computing device 104 to designate candidate side branch pairs 128 and matched side branches 130. Said differently, where the candidate side branch pairs 128 comprises a 1:N (n>1) relationship between paired side branches, for example, where a side branch from IVUS images side branch information 124 is paired with two side branches from angiography image side branch information 122, or vice versa, processor 106 can execute instructions 116 to cause computing device 104 to remove one or more pairs from candidate side branch pairs 128 to generate 130 having a 1:1 paring (or mapping) between side branches from angiography image side branch information 122 and IVUS images side branch information 124.

Processor 106 can execute instructions 116 to cause computing device 104 to identify low confidence side branch matches 132 and generate confirmed side branch matches 134 based in part on matched side branches 130 and low confidence side branch matches 132. For example, pairs identified in matched side branches 130 with a confidence value below a threshold can be removed from matched side branches 130, resulting in confirmed side branch matches 134.

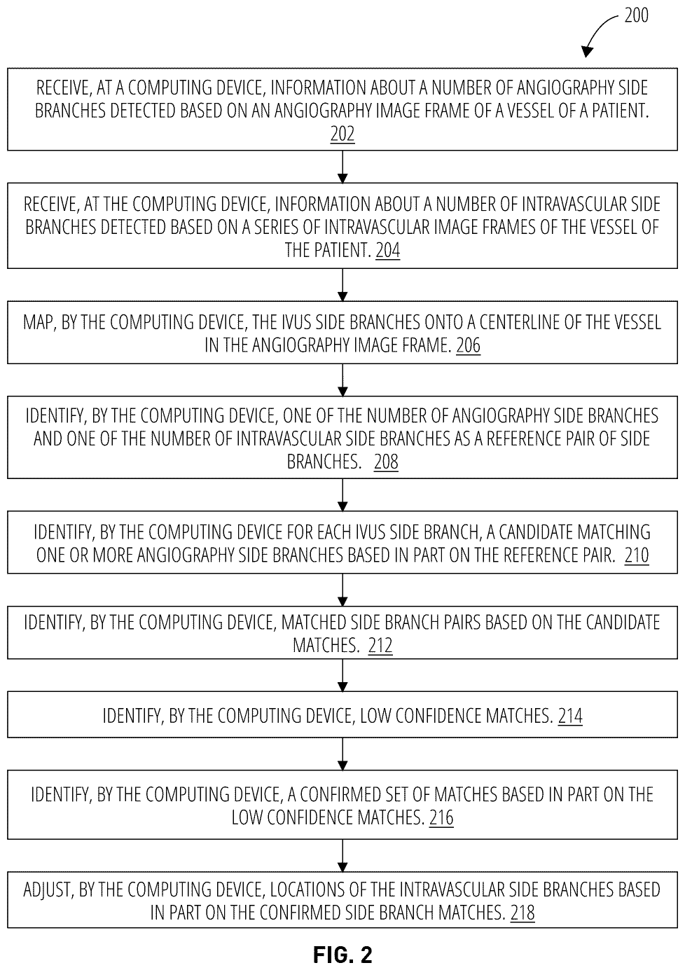

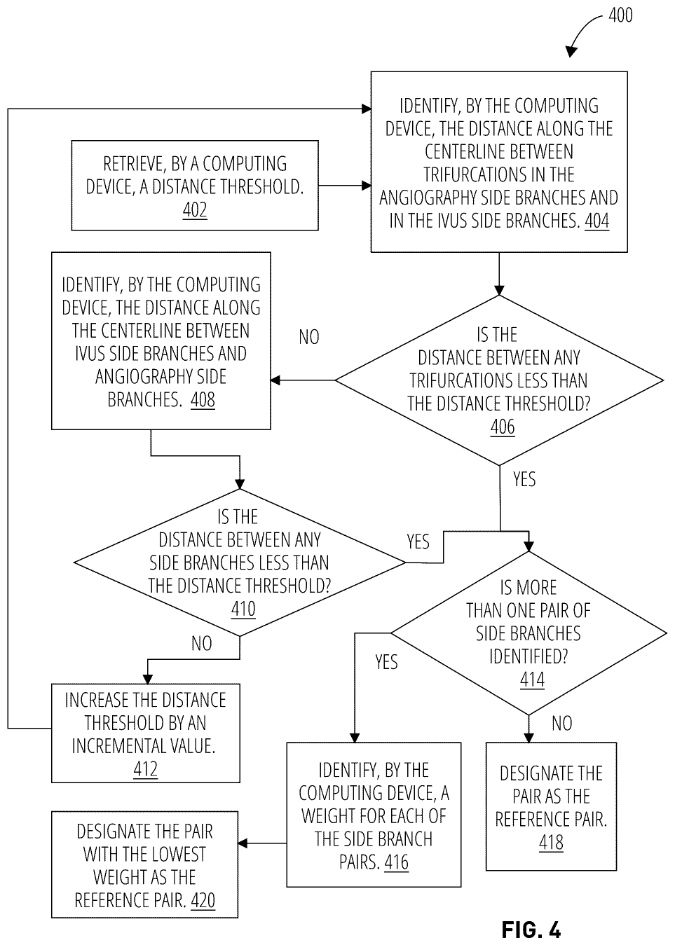

FIG. 2 and FIG. 4 illustrate routines 200 and 400, respectively, according to some embodiments of the present disclosure. Routines 200 can be implemented by side branch matching system 100, or another computing device, as outlined herein to match angiography and IVUS side branches and adjust the IVUS side branch locations on the angiography image based on the matching. For example, routine 200 can be implemented to match angiography and IVUS side branches while routine 400 can be implemented as part of routine 200 to identify a reference pair of side branches.

Routine 200 can begin at block 202 “receive, at a computing device, information about a number of angiography side branches detected based on an angiography image frame of a vessel of a patient” information about side branches detected based on an angiography image frame can be received at a computing device. For example, processor 106 can execute instructions 116 to cause computing device 104 to receive angiography image side branch information 122. In some examples, processor 106 can execute instructions 116 at block 202 to cause computing device 104 to also receive angiography image frame 118.

Continuing to block 204 “receive, at the computing device, information about a number of intravascular side branches detected based on a series of intravascular image frames of the vessel of the patient” information about side branches detected based on a series of IVUS image frames can be received at a computing device. For example, processor 106 can execute instructions 116 to cause computing device 104 to receive IVUS images side branch information 124. In some examples, processor 106 can execute instructions 116 at block 204 to cause computing device 104 to also receive IVUS image frames 120.

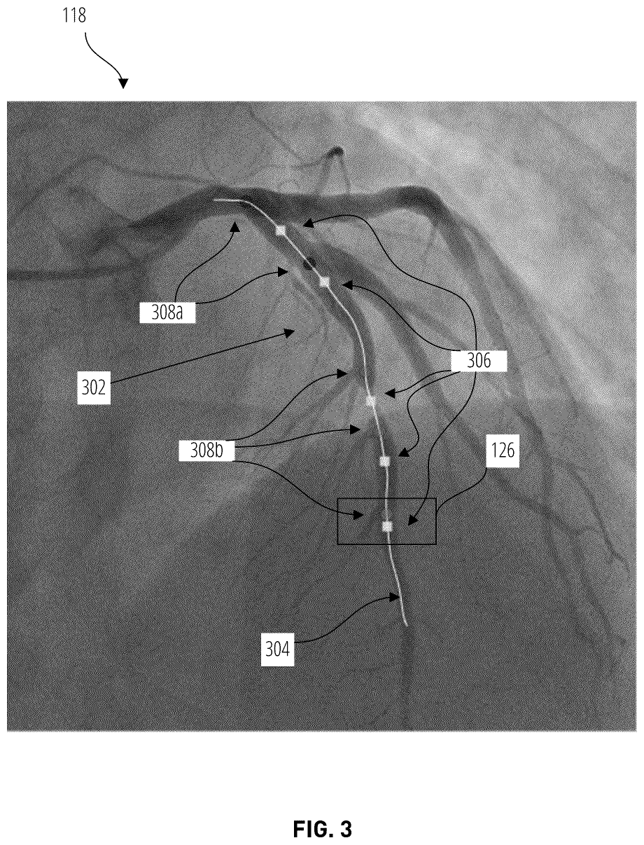

Continuing to block 206 “map, by the computing device, the side branches onto a centerline of the vessel in the angiography image frame” the IVUS side branches can be mapped onto a centerline of the vessel in the angiography image frame. For example, processor 106 can execute 116 to map the side branches onto a centerline of the vessel in the angiography image frame 118. This is illustrated in greater detail in FIG. 3.

FIG. 3 illustrate an example of mapping side branches onto a centerline of a vessel and identifying a reference pair of side branches, according to some embodiments. This figure is depicted with reference to side branch matching system 100 and angiography image frame 118. As illustrated, angiography image frame 118 comprises an indication of a vessel 302 having a centerline 304. In general, centerline 304 can correspond to the pullback path associated with IVUS image frames 120. Identification of the centerline is beyond the scope of this disclosure. Further, FIG. 3 illustrates IVUS side branches 306 and angiography side branches 308a and 308b mapped onto the centerline 304. Initial mapping and placement of side branches is also beyond the scope of this disclosure. However, in general, any of a variety of techniques to identify a centerline for angiography/IVUS co-registration and place IVUS side branches on the centerline can be utilized.

As noted above, angiography image side branch information 122 and IVUS images side branch information 124 comprise indications of more than merely the location of the side branch. For example, angiography image side branch information 122 and IVUS images side branch information 124 comprise indications of the orientation (e.g., left hand or right hand, angular rotation, etc.) of the side branch. In this image depicted in FIG. 3, angiography side branches 308a are right hand orientated side branches while 308b are left hand orientated side branches.

Returning to FIG. 2, routine 200 can continue to block 208 “identify, by the computing device, one of the number of angiography side branches and one of the number of intravascular side branches as a reference pair of side branches” one of the side branches associated with angiography image side branch information 122 and one of the side branches associated with IVUS images side branch information 124 can be identified as a reference pair of side branches. FIG. 4 illustrates routine 400, which can be implemented to identify a reference pair at block 208 of routine 200. This is described in greater detail below. However, in general, at block 208, computing device 104 can identify the “pair” of angiography and IVUS side branches having the highest confidence of being the same side branch. For example, processor 106 can execute instructions 116 to identify this pair of side branches and designate them as reference side branch pair 126. Reference side branch pair 126 enables the correlation of which IVUS angle corresponds to which angiography side branch orientation (e.g., left, right, etc.).

FIG. 4 illustrates routine 400, which can begin at block 402 and provides a technique to identify a reference pair of side branches. At block 402 “retrieve, by a computing device, a distance threshold” a distance threshold can be retrieved by the computing device. For example, processor 106 can execute instructions 116 to retrieve a distance threshold (e.g., from memory, from a register location, or the like). With some embodiments, the distance threshold is 2 millimeters. In other embodiments, the distance threshold is 5 millimeters. With some embodiments, the distance threshold can be between 2 millimeters and 10 millimeters.

Continuing to block 404 “identify, by the computing device, the distance along the centerline between trifurcations in the angiography side branches and in the IVUS side branches” the distance between trifurcations in the angiography side branches and the IVUS side branches can be identified. For example, processor 106 can execute instructions 116 to identify the distance between angiography and IVUS trifurcations based on the angiography image side branch information 122 and IVUS images side branch information 124.

Continuing to decision block 406 “is the distance between any trifurcations less than the distance threshold?” a determination can be made of whether the distance between angiography and IVUS trifurcations is less than the distance threshold. For example, processor 106 can execute instructions 116 to determine whether the distance along the centerline 304 between any angiography trifurcations and IVUS trifurcations identified at block 404 is less than the distance threshold. From decision block 406, routine 400 can continue to either block 408 or decision block 414. Routine 400 can continue from decision block 406 to block 408 based on a determination at decision block 406 that the distance between any angiography and IVUS trifurcations is not less than the distance threshold while routine 400 can continue from decision block 406 to decision block 414 based on a determination at decision block 406 that the distance between any angiography and IVUS trifurcations is less than the distance threshold.

In some embodiments, where multiple trifurcations are identified at decision block 406, processor 106 can execute instructions 116 to reduce the distance threshold until a single pair of IVUS and angiography side branches is identified as having a difference between trifurcations of less than the threshold distance. Or rather, the bifurcation with the smallest difference in distance can be identified.

At block 408 “identify, by the computing device, the distance along the centerline between IVUS side branches and angiography side branches” the distance along the centerline between IVUS and angiography side branches can be determined. For example, processor 106 can execute instructions 116 to identify the distance along the centerline 304 between IVUS side branches 306 and angiography side branches 308a or 308b. Continuing to decision block 410 “is the distance between any side branches less than the distance threshold?” a determination can be made of whether the distance between angiography and IVUS side branches is less than the distance threshold. For example, processor 106 can execute instructions 116 to determine whether the distance along the centerline 304 between IVUS side branches 306 and angiography side branches 308a and 308b identified at block 408 is less than the distance threshold. From decision block 410, routine 400 can continue to either block 412 or decision block 414. Routine 400 can continue from decision block 410 to block 412 based on a determination at decision block 410 that the distance between any angiography and IVUS side branches is not less than the distance threshold while routine 400 can continue from decision block 410 to decision block 414 based on a determination at decision block 410 that the distance between any angiography and IVUS side branches is less than the distance threshold.

At block 412 “increase the distance threshold by an incremental value” the distance threshold can be increased by an incremental value (e.g., 0.2 millimeters, or the like). For example, processor 106 can execute instructions 116 to increment the distance threshold by an incremental value. From block 412, routine 400 can return to block 404 and continue identifying side branch pairs as outlined.

At decision block 414 “is more than one pair of side branches identified?” a determination is made as to whether more than one pair of side branches is identified at either decision block 406 or decision block 410. For example, processor 106 can execute instructions 116 to determine whether more than one pair of side branches is identified (e.g., either multiple 1:1 pairs, a combination of 1:1 and 1:n pairs, or at least one (1) 1:n pair). From decision block 414, routine 400 can continue to either block 416 or block 418. Routine 400 can continue from decision block 414 to block 416 based on a determination at decision block 414 that there are more than one pair of side branches identified while routine 400 can continue from decision block 414 to block 418 based on a determination at decision block 414 there is only one pair of side branches identified.

At block 416 “identify, by the computing device, a weight for each of the side branch pairs” a weight for each of the side branch pairs can be identified. For example, processor 106 can execute instructions 116 to identify a weight for each of the side branch pairs identified at either decision block 406 or decision block 410. In some embodiments, the weight can be a sum of the difference between the distance, along the centerline 304, of the IVUS side branches 306 and angiography side branches 308a or 308b and the difference between the diameter of the IVUS side branches 306 and angiography side branches 308a or 308b.

Continuing to block 420 “designate the pair with the lowest weight as the reference pair” the pair with the lower weight can be designated as the reference pair. For example, processor 106 can execute instructions 116 to designate the pair of IVUS side branch 306 and angiography side branch 308a or 308b with the lower weight as the reference side branch pair 126.

At block 418 “designate the pair as the reference pair” the pair can be designated as the reference pair. For example, processor 106 can execute instructions 116 to designate the pair of IVUS side branch 306 and angiography side branch 308a or 308b as the reference side branch pair 126.

FIG. 3 illustrates reference side branch pair 126, which can be identified based on routine 400. Returning to FIG. 2, routine 200 can continue to block 210 “identify, by the computing device for each IVUS side branch, a candidate matching one or more angiography side branches based in part on the reference pair” candidate or potential matches between angiography and IVUS side branches can be identified. For example, processor 106 can execute instructions 116 to identify potential matches between IVUS side branches 306 and angiography side branches 308a or 308b based on the reference side branch pair 126 and the angiography image side branch information 122 and IVUS images side branch information 124. Further, processor 106 can execute instructions 116 to designate the potential matches as candidate side branch pairs 128. In some embodiments, processor 106 can execute instructions 116 to identify candidate side branch pairs 128 based on the distance along the centerline 304 between the side branches and/or the orientation of the side branches. For example, the orientation can be keyed based on the reference side branch pair 126. As such, processor 106 can execute instructions 116 to identify, for each IVUS side branch 306, ones of the angiography side branches 308a or 308b having a similar orientation located within a threshold distance along the centerline 304.

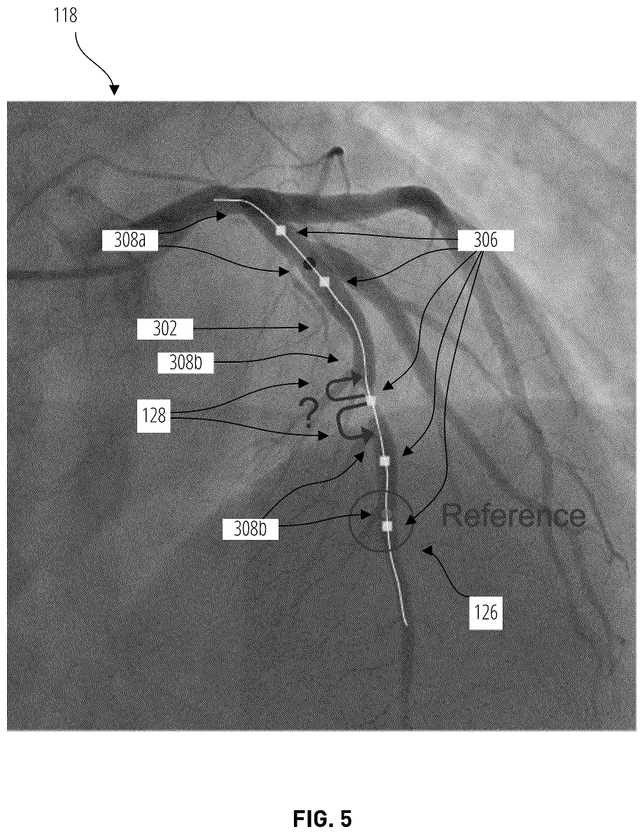

FIG. 5 illustrate an example of identifying potential or candidate side branch pairs. This figure is depicted with reference to side branch matching system 100 and angiography image frame 118. For example, the indicated IVUS side branch 306 could be potential matched to either of the adjacent angiography side branches 308a. That is, processor 106 could execute instructions 116 to identify a potential match between the IVUS side branch 306 identified in this figure and either of the adjacent angiography side branches 308a (e.g., based on the distance between the side branches along the centerline 304, or the like) and designate this potential match as one of candidate side branch pairs 128.

Returning to FIG. 2, routine 200 can continue to block 212 “identify, by the computing device, matched side branch pairs based on the candidate matches” 1:1 pairs of side branch matches can be identified based on the candidate matches. For example, processor 106 can execute instructions 116 to identify matched side branch pairs from candidate side branch pairs where each pair is a 1:1 match between an IVUS and angiography side branch based on angiography image side branch information 122 and IVUS images side branch information 124. In some embodiments, processor 106 can execute to modify 1: n matches in candidate side branch pairs 128 based on the weight (e.g., sum of differences between distance and diameter, or the like) of each candidate match. For example, referring to FIG. 5, the called out IVUS side branch 306 could be designated as a pair in matched side branches 130 with the adjacent angiography side branch 308a with the smallest weight, or rather, the one of the adjacent angiography side branches 308a that has the least sum of the difference of the distance between the IVUS side branch 306 and the angiography side branch 308a and the difference between the diameters of IVUS side branch 306 and angiography side branch 308a. Further, processor 106 can execute instructions 116 to designate the 1:1 matches as matched side branches 130.

Continuing to block 214 “identify, by the computing device, low confidence matches” pairs in matched side branches 130 having a low confidence can be identified. For example, processor 106 can execute instructions 116 to identify a confidence of the pairs in matched side branches 130 and determine which, if any, of the pairs have a confidence below a threshold value and designate these pairs as low confidence side branch matches 132. In some embodiments, the confidence can be a difference between the diameters, a difference between the distance, or the weight (e.g., sum of difference between distance and diameter).

Continuing to block 216 “identify, by the computing device, a confirmed set of matches based in part on the low confidence pairs” a confirmed set of matched pairs can be identified by removing the low confidence pairs from the matched side branches. For example, processor 106 can execute instructions 116 to identify confirmed side branch matches 134 based on removing low confidence side branch matches 132 from matched side branches 130.

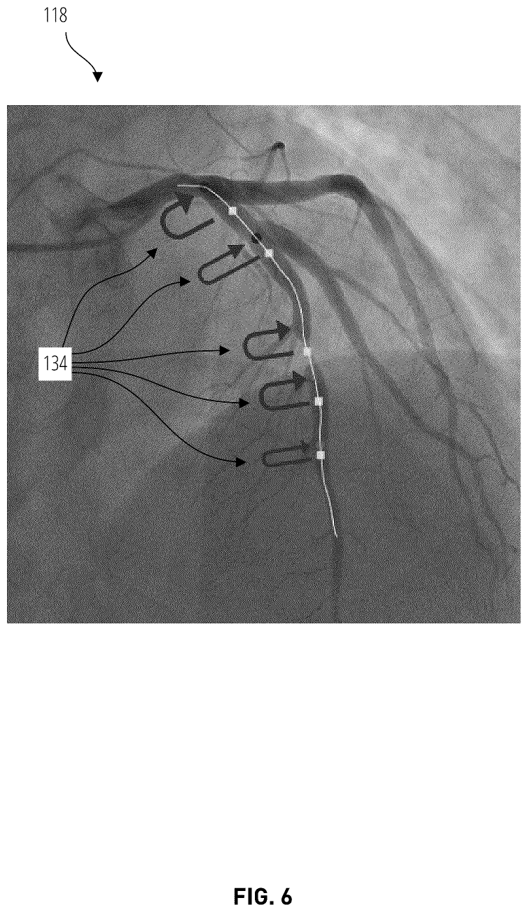

FIG. 6 illustrate an example of confirmed side branch matches 134 indicated on angiography image frame 118. Returning to FIG. 2, routine 200 can continue to block 218 “adjust, by the computing device, locations of the intravascular side branches based in part on the confirmed side branch matches” locations of the IVUS side branches can be adjusted based on the confirmed side branch matches. For example, processor 106 can execute instructions 116 to adjust the locations (e.g., location index, grid coordinates, pixel reference, or the like) of the side branches associated with IVUS images side branch information 124 based on the confirmed side branch matches 134. In particular, the locations can be shifted to correlate with the matched angiography side branches in a linear manner.

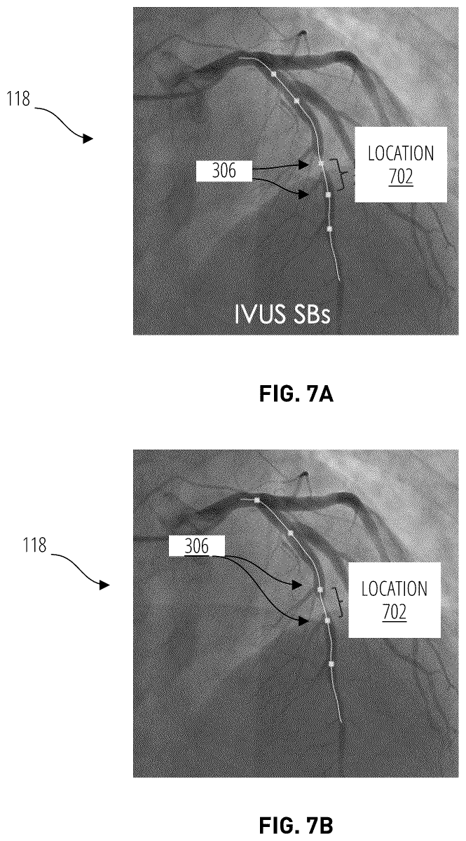

FIG. 7A and FIG. 7B illustrate examples of adjusting the locations 702, or location index, of some of the IVUS side branches 306 based on the confirmed side branch matches 134. For example, the locations 702 for the IVUS side branches 306 depicted in FIG. 7A are adjusted based on confirmed side branch matches 134, as shown in FIG. 7B.

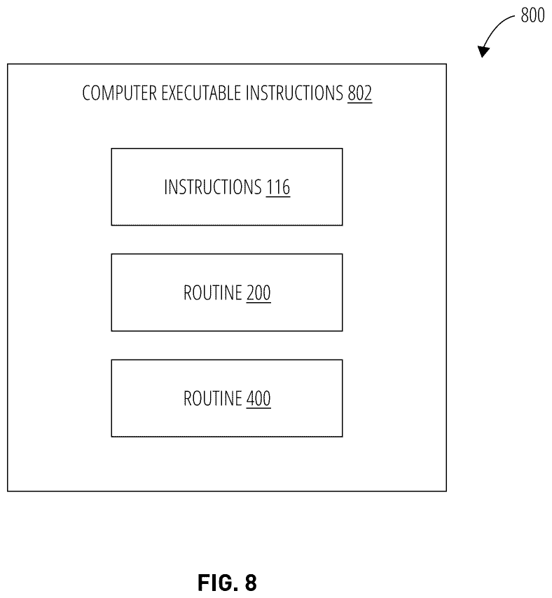

FIG. 8 illustrates computer-readable storage medium 800. Computer-readable storage medium 800 may comprise any non-transitory computer-readable storage medium or machine-readable storage medium, such as an optical, magnetic or semiconductor storage medium. In various embodiments, computer-readable storage medium 800 may comprise an article of manufacture. In some embodiments, computer-readable storage medium 800 may store computer executable instructions 802 with which circuitry (e.g., processor 106, or the like) can execute. For example, computer executable instructions 802 can include instructions to implement operations described with respect side branch matching system 100, which can improve the functioning of side branch matching system 100 as detailed herein. For example, computer executable instructions 802 can include instructions that can cause a computing device to implemented routine 200 of FIG. 2 or routine 400 of FIG. 4. As another example, computer executable instructions 802 can include instructions 116. Examples of computer-readable storage medium 800 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 802 may include any suitable type of code, such as source code, compiled code, interpreted code, executable code, static code, dynamic code, object-oriented code, visual code, and the like.

FIG. 9 illustrates a combined internal and external imaging system 900 including both an endoluminal imaging system 902 (e.g., an IVUS imaging system, or the like) and an extravascular imaging system 904 (e.g., an angiographic imaging system). Combined internal and external imaging system 900 further includes computing device 906, which includes circuitry, controllers, and/or processor(s) and memory and software as needed. With some embodiments, side branch matching system 100 can be incorporated into computing device 906 or side branch matching system 100 can incorporate computing device 906. In general, the endoluminal imaging system 902 can be arranged to generate intravascular imaging data (e.g., IVUS images, or the like) while the extravascular imaging system 904 can be arranged to generate extravascular imaging data (e.g., angiography images, or the like).

The extravascular imaging system 904 may include a table 908 that may be arranged to provide sufficient space for the positioning of an angiography/fluoroscopy unit c-arm 910 in an operative position in relation to a patient 912 on the drive unit. C-arm 910 can be configured to acquires fluoroscopic images in the absence of contrast agent in the blood vessels of the patient 912 and/or acquire angiographic image while there is a presence of contrast agent in the blood vessels of the patient 912.

Raw radiological image data acquired by the c-arm 910 may be passed to an extravascular data input port 914 via a transmission cable 916. The input port 914 may be a separate component or may be integrated into or be part of the computing device 906. The input port 914 may include a processor that converts the raw radiological image data received thereby into extravascular image data (e.g., angiographic/fluoroscopic image data), for example, in the form of live video, DICOM, or a series of individual images. The extravascular image data may be initially stored in memory within the input port 914 or may be stored within memory of computing device 906. If the input port 914 is a separate component from the computing device 906, the extravascular image data may be transferred to the computing device 906 through the transmission cable 916 and into an input port (not shown) of the computing device 906. In some alternatives, the communications between the devices or processors may be carried out via wireless communication, rather than by cables as depicted.

The intravascular imaging data may be, for example, IVUS data or OCT data obtained by the endoluminal imaging system 902. The endoluminal imaging system 902 may include an intravascular imaging device such as an imaging catheter 920. The imaging catheter 920 is configured to be inserted within the patient 912 so that its distal end, including a diagnostic assembly or probe 922 (e.g., an IVUS probe), is in the vicinity of a desired imaging location of a blood vessel. A radiopaque material or marker 924 located on or near the probe 922 may provide indicia of a current location of the probe 922 in a radiological image. In some embodiments, imaging catheter 920 and/or probe 922 can include a guide catheter (not shown) that has been inserted into a lumen of the subject (e.g., a blood vessel, such as a coronary artery) over a guidewire (also not shown). However, in some embodiments, the imaging catheter 920 and/or probe 922 can be inserted into the vessel of the patient 912 without a guidewire.

With some embodiments, imaging catheter 920 and/or probe 922 can include both imaging capabilities as well as other data-acquisition capabilities. For example, FFR and/or iFR data, data related to pressure, flow, temperature, electrical activity, oxygenation, biochemical composition, or any combination thereof. In some embodiments, imaging catheter 920 and/or probe 922 can further include a therapeutic device, such as a stent, a balloon (e.g., an angioplasty balloon), a graft, a filter, a valve, and/or a different type of therapeutic endoluminal device.

Imaging catheter 920 is coupled to a proximal connector 926 to couple imaging catheter 920 to image acquisition device 928. Image acquisition device 928 may be coupled to computing device 906 via transmission cable 916, or a wireless connection. The intravascular image data may be initially stored in memory within the image acquisition device 928 or may be stored within memory of computing device 906. If the image acquisition device 928 is a separate component from computing device 906, the intravascular image data may be transferred to the computing device 906, via, for example, transmission cable 916.

The computing device 906 can also include one or more additional output ports for transferring data to other devices. For example, the computer can include an output port to transfer data to a data archive or memory device 932. The computing device 906 can also include a user interface (described in greater detail below) that includes a combination of circuitry, processing components and instructions executable by the processing components and/or circuitry to enable the image identification and vessel routing or pathfinding described herein and/or dynamic co-registration of intravascular and extravascular images using the identified vessel pathway.

In some embodiments, computing device 906 can include user interface devices, such as, a keyboard, a mouse, a joystick, a touchscreen device (such as a smartphone or a tablet computer), a touchpad, a trackball, a voice-command interface, and/or other types of user interfaces that are known in the art.

The user interface can be rendered and displayed on display 934 coupled to computing device 906 via display cable 936. Although the display 934 is depicted as separate from computing device 906, in some examples the display 934 can be part of computing device 906. Alternatively, the display 934 can be remote and wireless from computing device 906. As another example, the display 934 can be part of another computing device different from computing device 906, such as, a tablet computer, which can be coupled to computing device 906 via a wired or wireless connection. For some applications, the display 934 includes a head-up display and/or a head-mounted display. For some applications, the computing device 906 generates an output on a different type of visual, text, graphics, tactile, audio, and/or video output device, e.g., speakers, headphones, a smartphone, or a tablet computer. For some applications, the user interface rendered on display 934 acts as both an input device and an output device.

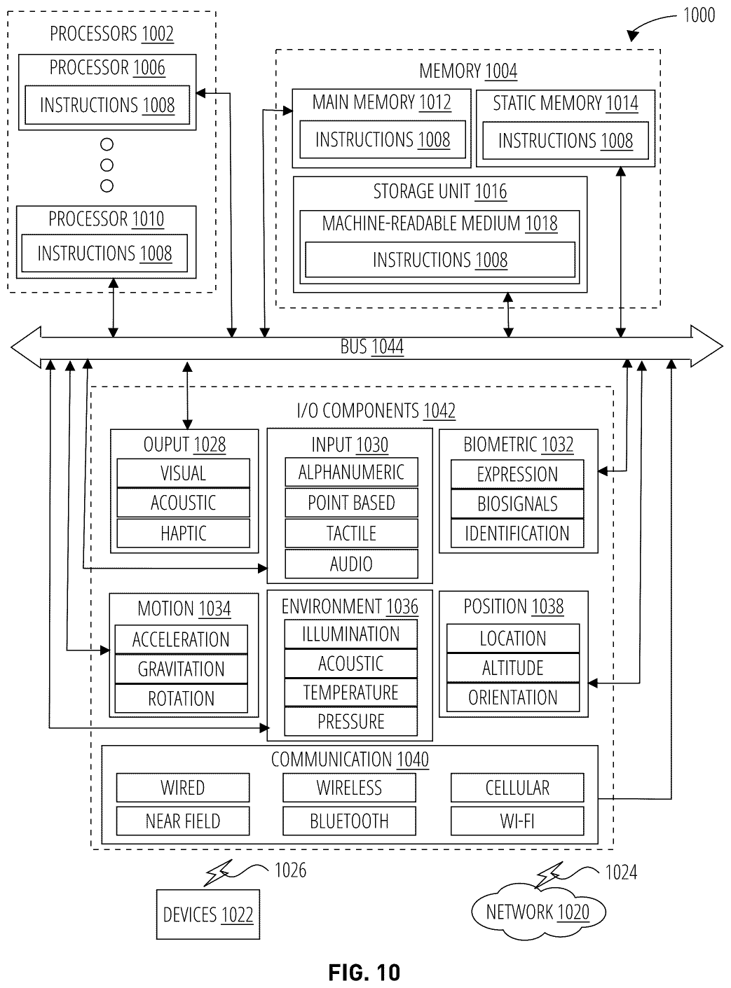

FIG. 10 illustrates a diagrammatic representation of a machine 1000 in the form of a computer system within which a set of instructions may be executed for causing the machine to perform any one or more of the methodologies discussed herein. More specifically, FIG. 10 shows a diagrammatic representation of the machine 1000 in the example form of a computer system, within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute instructions 116, routine 200 of FIG. 2 or routine 400 of FIG. 4, or the like. More generally, the instructions 1008 may cause the machine 1000 to match IVUS and angiography side branches as outlined herein.

The instructions 1008 transform the general, non-programmed machine 1000 into a particular machine 1000 programmed to carry out the described and illustrated functions in a specific manner. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines 200 that individually or jointly execute the instructions 1008 to perform any one or more of the methodologies discussed herein.

The machine 1000 may include processors 1002, memory 1004, and I/O components 1042, which may be configured to communicate with each other such as via a bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1006 and a processor 1010 that may execute the instructions 1008. The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 may include a main memory 1012, a static memory 1014, and a storage unit 1016, both accessible to the processors 1002 such as via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones will likely include a touch input device or other such input mechanisms, while a headless server machine will likely not include such a touch input device. It will be appreciated that the I/O components 1042 may include many other components that are not shown in FIG. 10. The I/O components 1042 are grouped according to functionality merely for simplifying the following discussion and the grouping is in no way limiting. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1042 may include biometric components 1032, motion components 1034, environmental components 1036, or position components 1038, among a wide array of other components. For example, the biometric components 1032 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 may include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (i.e., memory 1004, main memory 1012, static memory 1014, and/or memory of the processors 1002) and/or storage unit 1016 may store one or more sets of instructions and data structures (e.g., software) embodying or utilized by any one or more of the methodologies or functions described herein. These instructions (e.g., the instructions 1008), when executed by processors 1002, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1020 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1020 or a portion of the network 1020 may include a wireless or cellular network, and the coupling 1024 may be a Code Division Multiple Access (CDMA) connection, a Global System for Mobile communications (GSM) connection, or another type of cellular or wireless coupling. In this example, the coupling 1024 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1008 may be transmitted or received over the network 1020 using a transmission medium via a network interface device (e.g., a network interface component included in the communication components 1040) and utilizing any one of several well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022. The terms “transmission medium” and “signal medium” mean the same thing and may be used interchangeably in this disclosure. The terms “transmission medium” and “signal medium” shall be taken to include any intangible medium that can store, encoding, or carrying the instructions 1008 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

What is claimed is:

1. An apparatus for a cross modality image co-registration system, comprising:
a processor arranged to be coupled to an intravascular imaging device and/or a fluoroscope device; and
a memory storage device comprising instructions executable by the processor, which instructions when executed by the processor cause the apparatus to:
identify first side branches in a first image frame, the first image frame corresponding to a first imaging modality;
identify second side branches in a plurality of second image frames, the plurality of second image frames corresponding to a second imaging modality different than the first imaging modality;
match, without user input, ones of the first side branches with ones of the second side branches; and
co-register the plurality of second image frames with the first image frame based on the matching,
wherein co-registering the plurality of second image frames comprises adjusting locations of the second side branches on the first image frame.

2. The apparatus of claim 1, wherein the first imaging modality is x-ray angiography and where the second imaging modality is intravascular ultrasound, optical coherence tomography, or computed tomography (CT) angiography.

3. The apparatus of claim 1, the instructions when executed to match ones of the first side branches with ones of the second side branches further cause the apparatus to:
identify one of a plurality of first side branches and one of a plurality of second side branches as a reference pair of side branches;
identify a plurality of candidate pairs of side branches based in part on the reference pair of side branches, wherein each candidate pair of side branches of the plurality of candidate pairs includes at least one of the plurality of first side branches and at least one of the plurality of second side branches; and
identify a plurality of matched pairs of side branches from the plurality of candidate pairs of side branches based in part on characteristics of the plurality of first side branches and the plurality of second side branches, wherein each pair of the plurality of matched pairs of side branches includes a one of the plurality of first side branches and a one of the plurality of second side branches.

4. The apparatus of claim 3, wherein the characteristics includes one or more of a diameter of the side branch, an orientation of the side branch, a relative size of the side branch, or a relative location of the side branch.

5. The apparatus of claim 4, the instructions when executed identify one of the plurality of first side branches and one of the plurality of second side branches as the reference pair of side branches further cause the apparatus to:
identifying, by the computing device, the distance along a centerline of the vessel between bifurcations in the first side branches and the second side branches;
determining if the distance between trifurcations in the first side branches and the second side branches is less than a threshold distance; and
designating, based on a determination that the distance between trifurcations is less than the threshold distance, the pair of first and second side branches as the reference pair of side branches.

6. The apparatus of claim 5, the instructions when executed further cause the apparatus to:
determine whether more than one pair of first and second side branches are identified as having the distance between trifurcations of less than the threshold distance; and
designate, based on a determination that more than one pair of first and second side branches has the distance between trifurcations of less than the threshold distance, the pair of first and second side branches having the smallest distance between trifurcations as the reference pair of side branches.

7. The apparatus of claim 5, the instructions when executed further cause the apparatus to:
determine whether more than one pair of first and second side branches are identified as having the distance between trifurcations of less than the threshold distance; and
designate, based on a determination that more than one pair of first and second side branches has the distance between trifurcations of less than the threshold distance, the pair of first and second side branches having the smallest weight as the reference pair of side branches,
wherein the weight is defined as the sum of the difference between the distance between trifurcation and the difference between the diameter of the side branches.

8. The apparatus of claim, the instructions when executed further cause the apparatus to:
identify, based on a determination that the distance between trifurcations is not less than the threshold distance, the distance along the centerline between first and second side branches;
determine if the distance along the centerline between first and second side branches is less than the threshold distance; and
designate, based on a determination that the distance between first and second side branches is less than the threshold distance, the first and second side branches as the reference pair of side branches.

9. The apparatus of claim 8, the instructions when executed further cause the apparatus to increase the threshold distance, based on a determination that the distance between first and second side branches is not less than the threshold distance.

10. The apparatus claim 8, the instructions when executed further cause the apparatus to:
determine whether more than one pair of first and second side branches are identified as having the distance between side branches along the centerline of less than the threshold distance; and
designate, based on a determination that more than one pair of first and second side branches has the distance between side branches along the centerline of less than the threshold distance, the pair of first and second side branches having the smallest distance between aide branches along the centerline as the reference pair of side branches.

11. The apparatus of claim 8, the instructions when executed further cause the apparatus to:
determine whether more than one pair of first and second side branches are identified as having the distance between side branches along the centerline of less than the threshold distance; and
designate, based on a determination that more than one pair of first and second side branches has the distance between side branches along the centerline of less than the threshold distance, the pair of first and second side branches having the smallest weight as the reference pair of side branches,
wherein the weight is defined as the sum of the difference between the distance between side branches along the centerline and the difference between the diameter of the side branches.

12. The apparatus of claim 11, wherein the confidence level is determined based in part on a difference between the diameter of the one of the plurality of first side branches and the one of the plurality of second side branches in each respective one of the plurality of matched side branch pairs.

13. A computer-readable storage device, comprising instructions executable by a processor of a computing device coupled to an intravascular imaging device and/or a fluoroscope device, wherein when executed the instructions cause the computing device to:
identify first side branches in a first image frame, the first image frame corresponding to a first imaging modality;
identify second side branches in a plurality of second image frames, the plurality of second image frames corresponding to a second imaging modality different than the first imaging modality;
match, without user input, ones of the first side branches with ones of the second side branches; and
co-register the plurality of second image frames with the first image frame based on the matching,
wherein co-registering the plurality of second image frames comprises adjusting locations of the second side branches on the first image frame.

14. The computer-readable storage device of claim 13, wherein the first imaging modality is x-ray angiography and where the second imaging modality is intravascular ultrasound, optical coherence tomography, or computed tomography (CT) angiography.

15. The computer-readable storage device of claim 13, the instructions when executed to match ones of the first side branches with ones of the second side branches further cause the computing device to:
identify one of a plurality of first side branches and one of a plurality of second side branches as a reference pair of side branches;
identify a plurality of candidate pairs of side branches based in part on the reference pair of side branches, wherein each candidate pair of side branches of the plurality of candidate pairs includes at least one of the plurality of first side branches and at least one of the plurality of second side branches; and
identify a plurality of matched pairs of side branches from the plurality of candidate pairs of side branches based in part on characteristics of the plurality of first side branches and the plurality of second side branches, wherein each pair of the plurality of matched pairs of side branches includes a one of the plurality of first side branches and a one of the plurality of second side branches.

16. The computer-readable storage device ratus of claim 15, wherein the characteristics includes one or more of a diameter of the side branch, an orientation of the side branch, a relative size of the side branch, or a relative location of the side branch.

17. The computer-readable storage device of claim 16, the instructions when executed identify one of the plurality of first side branches and one of the plurality of second side branches as the reference pair of side branches further cause the computing device to:
identifying, by the computing device, the distance along a centerline of the vessel between bifurcations in the first side branches and the second side branches;
determining if the distance between trifurcations in the first side branches and the second side branches is less than a threshold distance; and
designating, based on a determination that the distance between trifurcations is less than the threshold distance, the pair of first and second side branches as the reference pair of side branches.

18. The computer-readable storage device of claim 17, the instructions when executed further cause the computing device to:
determine whether more than one pair of first and second side branches are identified as having the distance between trifurcations of less than the threshold distance; and
designate, based on a determination that more than one pair of first and second side branches has the distance between trifurcations of less than the threshold distance, the pair of first and second side branches having the smallest distance between trifurcations as the reference pair of side branches.

19. A method for cross modality image co-registration, the method comprising:
identifying, by a computing device, first side branches in a first image frame, the first image frame corresponding to a first imaging modality;
identifying, by the computing device, second side branches in a plurality of second image frames, the plurality of second image frames corresponding to a second imaging modality different than the first imaging modality;
matching, by the computing device without user input, ones of the first side branches with ones of the second side branches; and
co-registering the plurality of second image frames with the first image frame based on the matching,
wherein co-registering the plurality of second image frames comprises adjusting locations of the second side branches on the first image frame.

20. The method of claim 19, further comprising:
identify one of a plurality of first side branches and one of a plurality of second side branches as a reference pair of side branches;
identify a plurality of candidate pairs of side branches based in part on the reference pair of side branches, wherein each candidate pair of side branches of the plurality of candidate pairs includes at least one of the plurality of first side branches and at least one of the plurality of second side branches; and
identify a plurality of matched pairs of side branches from the plurality of candidate pairs of side branches based in part on characteristics of the plurality of first side branches and the plurality of second side branches, wherein each pair of the plurality of matched pairs of side branches includes a one of the plurality of first side branches and a one of the plurality of second side branches.
